(19) United States
(12) Patent Application Publication
(10) Pub. No.: US 2026/0255360 A1
(43) Pub. Date: Aug. 27, 2026

(54) RETRANSMISSION IN SHARED RESOURCE

(71) Applicant: QUALCOMM Incorporated, San Diego, CA (US)

(72) Inventors: Qing LI, Princeton Junction, NJ (US); Linhai HE, San Diego, CA (US); Jing SUN, San Diego, CA (US); Ozcan OZTURK, San Diego, CA (US)

(21) Appl. No.: 19/065,850

(22) Filed: Feb. 27, 2025

(51) Int. Cl. H04W 72/231; H04L 5/00; H04W 72/12; H04W 76/20

(52) U.S. Cl. CPC H04W 72/231; H04L 5/0044; H04W 72/12; H04W 76/20

(57) ABSTRACT

Various aspects of the present disclosure generally relate to wireless communication. In some aspects, a user equipment (UE) may receive an identifier (ID) for the UE and a resource pool configuration associated with a resource allocation for downlink control information (DCI) associated with a retransmission grant within a resource pool shared by the UE and one or more other UEs. The UE may transmit a physical uplink shared channel (PUSCH) message based at least in part on the ID and the resource pool configuration. The UE may monitor for and receive the DCI in the resource allocation. The UE may transmit a retransmission of the PUSCH message in a resource associated with the retransmission grant. Numerous other aspects are described.

### FIELD OF THE DISCLOSURE

Aspects of the present disclosure generally relate to wireless communication and specifically relate to techniques, apparatuses, and methods associated with retransmission in a shared resource.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

A network entity may transmit a configured grant (CG) configuration to a user equipment (UE). The CG may identify a resource or set of resources available to the UE for transmission of an uplink communication (e.g., data or control information). For example, the CG configuration may identify a resource allocation to the UE for a physical uplink shared channel (PUSCH) message. To improve resource utilization, configured resources may be shared among multiple UEs. There may be collisions among UEs selecting the same resource(s), and the blind decoding overhead at the network entity may increase, consuming power and signaling resources. A network node may transmit downlink control information (DCI) for retransmission as an implicit negative acknowledgement (NACK) to an initial configured grant transmission, where the DCI may be transmitted in a dedicated resource pool for dynamic grant only or in a shared resource pool with CG (e.g., the same or different shared resource pool with the initial transmission). A network entity may transmit a retransmission grant DCI within a dedicated resource pool or a shared resource pool so that the UE can retransmit a PUSCH message. However, the DCI may be in one of multiple DCI transmission occasions or resource allocations. The UE may have to monitor the multiple DCI transmission occasions to receive the retransmission grant DCI, which consumes power.

Some aspects described herein relate to a UE that reduces its blind searching and decoding overhead for detecting a retransmission grant DCI by identifying a resource allocation for the retransmission grant DCI based at least in part on a UE identifier (ID) or a resource allocation for DCI. For example, a resource allocation for DCI may be based at least in part on a quantity of DCI time allocations and a quantity of DCI frequency allocations. In another example, a resource allocation for DCI may be based at least in part on the UE ID and a modulo operation with the quantity of time allocations or the quantity of frequency allocations within a resource pool. By using a DCI resource allocation or the UE ID for receiving a retransmission grant, the UE may monitor fewer DCI resource allocations (time and frequency allocations) and thus conserve power.

Some aspects described herein relate to a method of wireless communication performed by a UE. The method may include receiving an ID for the UE and a resource pool configuration associated with a resource allocation for DCI associated with a retransmission grant within a resource pool shared by the UE and one or more other UEs. The method may include transmitting a PUSCH message based at least in part on the ID and the resource pool configuration. The method may include monitoring for the DCI based at least in part on the resource allocation. The method may include receiving the DCI, wherein the DCI indicates the retransmission grant. The method may include transmitting a retransmission of the PUSCH message in a resource associated with the retransmission grant.

Some aspects described herein relate to a method of wireless communication performed by a network entity. The method may include transmitting an ID for a UE and a resource pool configuration associated with a resource allocation for DCI with a retransmission grant within a resource pool shared by the UE and one or more other

UEs. The method may include receiving a PUSCH message based at least in part on the ID and the resource pool configuration. The method may include transmitting the DCI based at least in part on the resource allocation the resource allocation.

Some aspects described herein relate to a method of wireless communication performed by a UE. The method may include transmitting a PUSCH message in a first resource allocation within a resource pool shared by more than one UE, based at least in part on a resource pool configuration. The method may include monitoring for feedback for the PUSCH message in a second resource allocation that is associated with the first resource allocation. The method may include transmitting a retransmission of the PUSCH message based at least in part on the feedback being a negative acknowledgment.

Some aspects described herein relate to a method of wireless communication performed by a network entity. The method may include transmitting a resource pool configuration for uplink messages that include small data transmissions in a resource pool shared by more than one UE. The method may include transmitting feedback in a second resource allocation based at least in part on whether an uplink message received in a first resource allocation is successfully decoded.

Some aspects described herein relate to a UE. The UE may include a processing system. The processing system may include one or more processors and one or more code-storing memories coupled with the one or more processors. The processing system may be configured to cause the UE to receive an ID for the UE and a resource pool configuration associated with a resource allocation for DCI associated with a retransmission grant within a resource pool shared by the UE and one or more other UEs. The processing system may be configured to cause the UE to transmit a PUSCH message based at least in part on the ID and the resource pool configuration. The processing system may be configured to cause the UE to monitor for the DCI based at least in part on the resource allocation for the DCI. The processing system may be configured to cause the UE to receive the DCI, wherein the DCI indicates the retransmission grant. The processing system may be configured to cause the UE to transmit a retransmission of the PUSCH message in a resource associated with the retransmission grant.

Some aspects described herein relate to a network entity. The network entity may include a processing system. The processing system may include one or more processors and one or more code-storing memories coupled with the one or more processors. The processing system may be configured to cause the network entity to transmit an ID for a UE and a resource pool configuration associated with a resource allocation for DCI with a retransmission grant within a resource pool shared by the UE and one or more other UEs. The processing system may be configured to cause the network entity to receive a PUSCH message based at least in part on the ID and the resource pool configuration. The processing system may be configured to cause the network entity to transmit the DCI based at least in part on the resource allocation for the DCI.

Some aspects described herein relate to a UE. The UE may include a processing system. The processing system may include one or more processors and one or more code-storing memories coupled with the one or more processors. The processing system may be configured to cause the UE to transmit a PUSCH message in a first resource allocation within a resource pool shared by more than one UE based at least in part on a resource pool configuration. The processing system may be configured to cause the UE to monitor for feedback for the uplink message in a second resource allocation that is associated with the first resource allocation. The processing system may be configured to cause the UE to transmit a retransmission of the PUSCH message based at least in part on the feedback being a negative acknowledgment.

Some aspects described herein relate to a network entity. The network entity may include a processing system. The processing system may include one or more processors and one or more code-storing memories coupled with the one or more processors. The processing system may be configured to cause the network entity to transmit a resource pool configuration for uplink messages that include small data transmissions in a resource pool shared by more than one UE. The processing system may be configured to cause the network entity to transmit feedback in a second resource allocation based at least in part on whether an uplink message received in a first resource allocation is successfully decoded.

Some aspects described herein relate to a non-transitory computer-readable medium that stores a set of instructions for wireless communication by a UE. The set of instructions, when executed by one or more processors of the UE, may cause the UE to receive an ID for the UE and a resource pool configuration associated with a resource allocation for DCI associated with a retransmission grant within a resource pool shared by the UE and one or more other UEs. The set of instructions, when executed by one or more processors of the UE, may cause the UE to transmit a PUSCH message based at least in part on the ID and the resource pool configuration. The set of instructions, when executed by one or more processors of the UE, may cause the UE to monitor for the DCI based at least in part on the resource allocation for the DCI. The set of instructions, when executed by one or more processors of the UE, may cause the UE to receive the DCI, wherein the DCI indicates the retransmission grant. The set of instructions, when executed by one or more processors of the UE, may cause the UE to transmit a retransmission of the PUSCH message in a resource associated with the retransmission grant.

Some aspects described herein relate to a non-transitory computer-readable medium that stores a set of instructions for wireless communication by a network entity. The set of instructions, when executed by one or more processors of the network entity, may cause the network entity to transmit an ID for a UE and a resource pool configuration associated with a resource allocation for DCI with a retransmission grant within a resource pool shared by the UE and one or more other UEs. The set of instructions, when executed by one or more processors of the network entity, may cause the network entity to receive a PUSCH message based at least in part on the ID and the resource pool configuration. The set of instructions, when executed by one or more processors of the network entity, may cause the network entity to transmit the DCI based at least in part on the resource allocation for the DCI.

Some aspects described herein relate to a non-transitory computer-readable medium that stores a set of instructions for wireless communication by a UE. The set of instructions, when executed by one or more processors of the UE, may cause the UE to transmit a PUSCH message in a first resource allocation within a resource pool shared by more than one UE, based at least in part on a resource pool configuration. The set of instructions, when executed by one or more processors of the UE, may cause the UE to monitor for feedback for the PUSCH message in a second resource allocation that is associated with the first resource allocation. The set of instructions, when executed by one or more processors of the UE, may cause the UE to transmit a retransmission of the PUSCH message based at least in part on the feedback being a negative acknowledgment.

Some aspects described herein relate to a non-transitory computer-readable medium that stores a set of instructions for wireless communication by a network entity. The set of instructions, when executed by one or more processors of the network entity, may cause the network entity to transmit a resource pool configuration for uplink messages that include small data transmissions in a resource pool shared by more than one UE. The set of instructions, when executed by one or more processors of the network entity, may cause the network entity to transmit feedback in a second resource allocation based at least in part on whether an uplink message received in a first resource allocation is successfully decoded.

Some aspects described herein relate to an apparatus for wireless communication. The apparatus may include means for receiving an ID for the apparatus and a resource pool configuration associated with a resource allocation for DCI associated with a retransmission grant within a resource pool shared by the apparatus and one or more other apparatuses. The apparatus may include means for transmitting a PUSCH message based at least in part on the ID and the resource pool configuration. The apparatus may include means for monitoring for the DCI based at least in part on the resource allocation for DCI. The apparatus may include means for receiving the DCI, wherein the DCI indicates the retransmission grant. The apparatus may include means for transmitting a retransmission of the PUSCH message in a resource associated with the retransmission grant.

Some aspects described herein relate to an apparatus for wireless communication. The apparatus may include means for transmitting an ID for another apparatus and a resource pool configuration associated with a resource allocation for DCI with a retransmission grant within a resource pool shared by the apparatus and one or more other apparatuses. The apparatus may include means for receiving a PUSCH message based at least in part on the ID and the resource pool configuration. The apparatus may include means for transmitting the DCI based at least in part on the resource allocation for the DCI.

Some aspects described herein relate to an apparatus for wireless communication. The apparatus may include means for transmitting an uplink message in a first resource allocation within a resource pool shared by more than one UE based at least in part on a resource pool configuration. The apparatus may include means for monitoring for feedback for the uplink message in a second resource allocation that is associated with the first resource allocation, where the second resource allocation is within a resource pool shared by multiple apparatuses. The apparatus may include means for transmitting a retransmission of the uplink message based at least in part on the feedback being a negative acknowledgment.

Some aspects described herein relate to an apparatus for wireless communication. The apparatus may include means for transmitting a resource pool configuration for uplink messages that include small data transmissions in a resource pool shared by more than one apparatus. The apparatus may include means for transmitting feedback in a second resource allocation based at least in part on whether an uplink message received in a first resource allocation is successfully decoded.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating an example of multiple configured grant configurations, in accordance with the present disclosure.

FIG. 4 is a diagram illustrating an example of uplink retransmission allocation, in accordance with the present disclosure.

FIG. 5 is a diagram illustrating an example of feedback for small data transmissions, in accordance with the present disclosure.

FIG. 6 is a diagram illustrating an example of resource pool management, in accordance with the present disclosure.

FIG. 7 is a diagram illustrating an example process performed, for example, at a user equipment (UE) or an apparatus of a UE.

FIG. 8 is a diagram illustrating an example process performed, for example, at a network entity or an apparatus of a network entity.

FIG. 9 is a diagram illustrating an example process performed, for example, at a UE or an apparatus of a UE.

FIG. 10 is a diagram illustrating an example process performed, for example, at a network entity or an apparatus of a network entity.

FIG. 11 is a diagram of an example apparatus for wireless communication.

FIG. 12 is a diagram of an example apparatus for wireless communication.

### DETAILED DESCRIPTION

A network entity may transmit a configured grant (CG) configuration to a user equipment (UE). For example, the network node may transmit configuration information that identifies the CG. The configuration information identifying the CG may indicate a resource allocation (e.g., in a time domain, frequency domain, spatial domain, or code domain) or a periodicity associated with the resource allocation. The CG may identify a resource or set of resources available to the UE for transmission of an uplink communication (e.g., data or control information). For example, the CG configuration may identify a resource allocation to the UE for a physical uplink shared channel (PUSCH) message.

Uplink (UL) CG may involve control signaling overhead (e.g., especially for small data transmission), and/or latency. A UE may be configured with multiple CG configurations with dedicated resource allocations, such as a number of contiguous slots within a period for a configuration within one UL bandwidth part (BWP). While UL CG improves the signaling overhead and latency, the dedicated resource utilization may not be optimized.

To improve resource utilization, configured resources may be shared among multiple UEs. For example, the CG configuration may identify one or multiple resource pools that may be available to multiple UEs for an uplink transmission. In some scenarios, there may be collisions among UEs selecting the same resource(s), and the blind decoding overhead at the network entity may increase, consuming power and signaling resources.

Furthermore, within a shared resource pool, it is possible that a PUSCH message pointed to by a UCI from a UE may collide at least partially with a PUSCH message pointed to by another UCI from another UE. Based on a decoded UCI (e.g., allocated with a UE ID), the network entity may schedule a dedicated grant (i.e., implicit negative acknowledgement (NACK) to the initial transmission) for one or more collision-free retransmissions. Within a shared resource pool, it is possible that two different UE IDs are mapped to the same transmission occasion for small data transmission. Based on the decoding, the network node may indicate acknowledgement (ACK) or NACK corresponding to a small data transmission.

A network node may transmit DCI for retransmission as an implicit NACK to an initial configured grant transmission, where the DCI may be transmitted in a dedicated resource pool for dynamic grant only or in a shared resource pool with CG (e.g., the same or different shared resource pool with the initial transmission). A network entity may transmit a retransmission grant DCI within a dedicated resource pool or a shared resource pool so that the UE can retransmit a PUSCH message. However, the DCI may be in one of multiple DCI transmission occasions or resource allocations. The UE may have to monitor the multiple DCI transmission occasions to receive the retransmission grant DCI, which consumes power.

Various aspects relate generally to CG. Some aspects more specifically relate to a UE that reduces its blind searching and decoding overhead for detecting a retransmission grant DCI by identifying a resource allocation for the retransmission grant DCI based at least in part on a UE identifier (ID) or a resource allocation for DCI. For example, a resource allocation for DCI may be based at least in part on a a quantity (e.g., M′) of DCI time allocations and a quantity (e.g., N′) of DCI frequency allocations. In another example, a resource allocation for DCI may be based at least in part on the UE ID and a modulo (mod) operation with a quantity M′ of time allocations or a quantity N′ of frequency allocations within a resource pool

Particular aspects of the subject matter described in this disclosure can be implemented to realize one or more of the following potential advantages. By using a resource allocation for DCI or the UE ID for receiving a retransmission grant, the UE may monitor fewer DCI resource allocations (time allocations) and thus conserve power.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

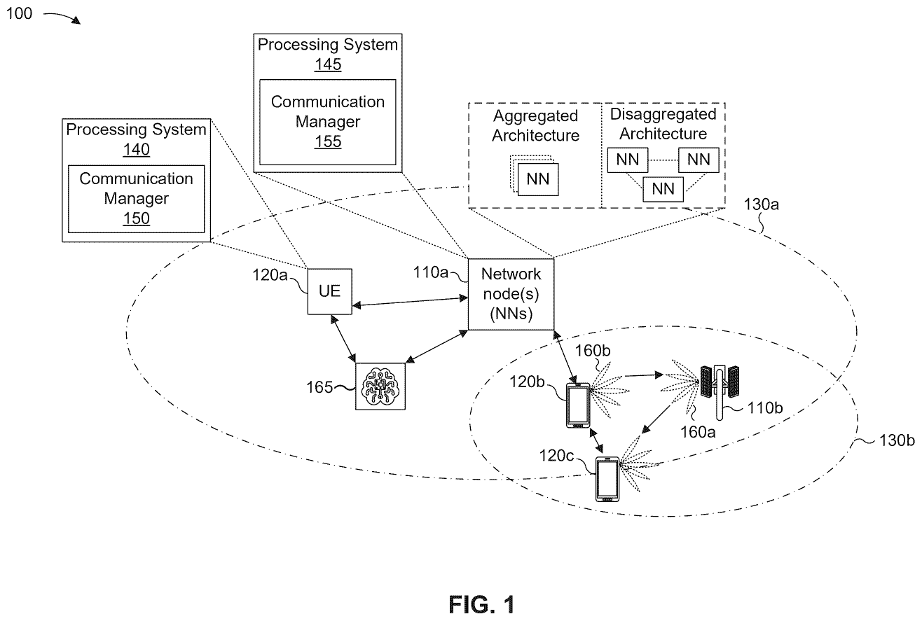

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR 4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit UCI from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include PUSCHs. Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ ACK indication or a HARQ NACK indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, a UE (e.g., a UE 120) may include a communication manager 150. As described in more detail elsewhere herein, the communication manager 150 may receive an ID for the UE and a resource pool configuration associated with a resource allocation for DCI associated with a retransmission grant within a resource pool shared by the UE and one or more other UEs; transmit a PUSCH message based at least in part on the ID and the resource pool configuration; monitor for the DCI based at least in part on the resource allocation for the DCI, wherein the DCI indicates the retransmission grant; receive the DCI in the resource allocation; and transmit a retransmission of the PUSCH message in a resource associated with the retransmission grant.

In some aspects, the communication manager 150 may transmit an uplink message in a first resource allocation within a resource pool shared by more than one UE based at least in part on a resource pool configuration; monitor for feedback for the uplink message in a second resource allocation that is associated with the first resource allocation; and transmit a retransmission of the uplink message based at least in part on the feedback being a negative acknowledgment. Additionally, or alternatively, the communication manager 150 may perform one or more other operations described herein.

In some aspects, a network entity (e.g., a network node 110) may include a communication manager 155. As described in more detail elsewhere herein, the communication manager 155 may transmit an ID for a UE and a resource pool configuration associated with a resource allocation for DCI with a retransmission grant within a resource pool shared by the UE and one or more other UEs; receive a PUSCH message based at least in part on the ID and the resource pool configuration; and transmit the DCI based at least in part on the resource allocation for the DCI.

In some aspects, the communication manager 155 may transmit a resource pool configuration for uplink messages that include small data transmissions in a resource pool shared by more than one UE; and transmit feedback in a second resource allocation based at least in part on whether an uplink message received in a first resource allocation is successfully decoded. Additionally, or alternatively, the communication manager 155 may perform one or more other operations described herein.

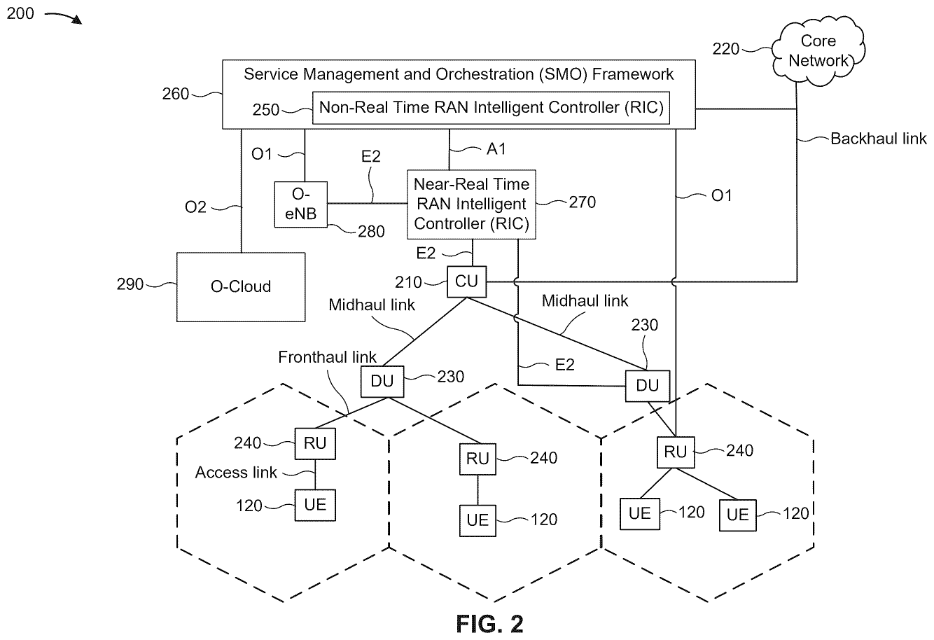

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

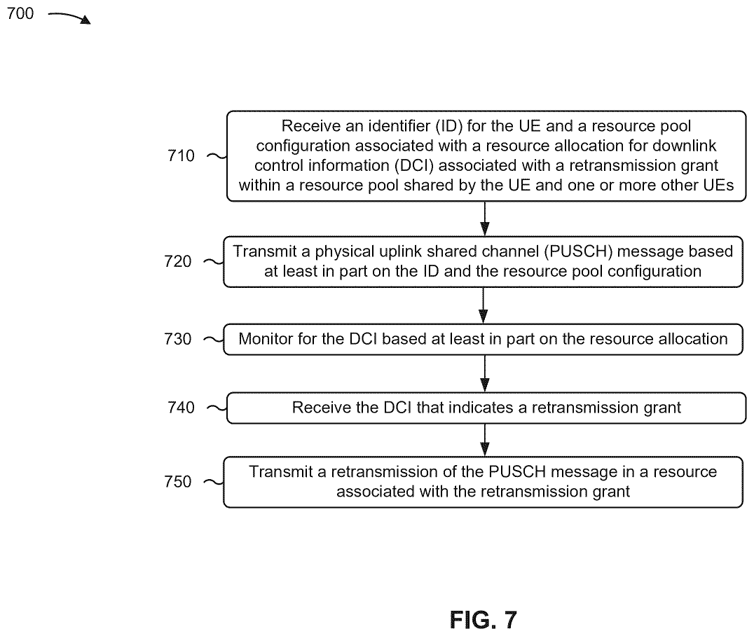

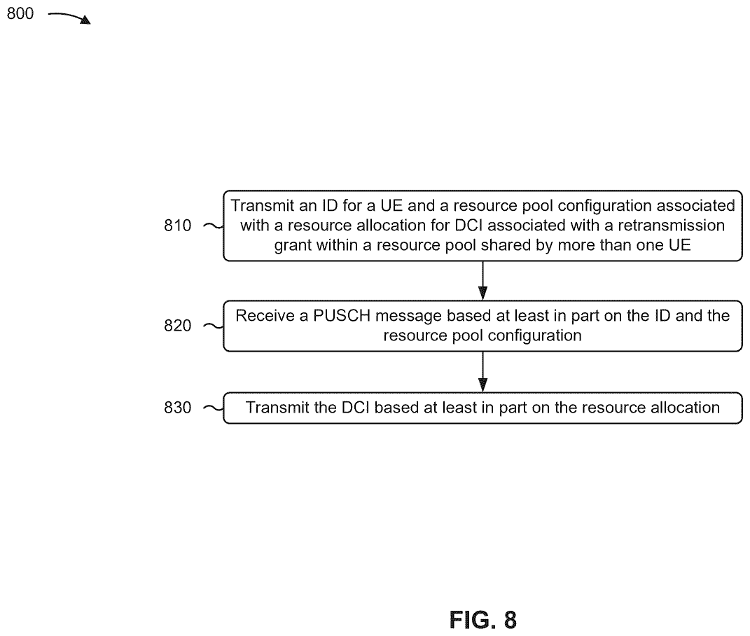

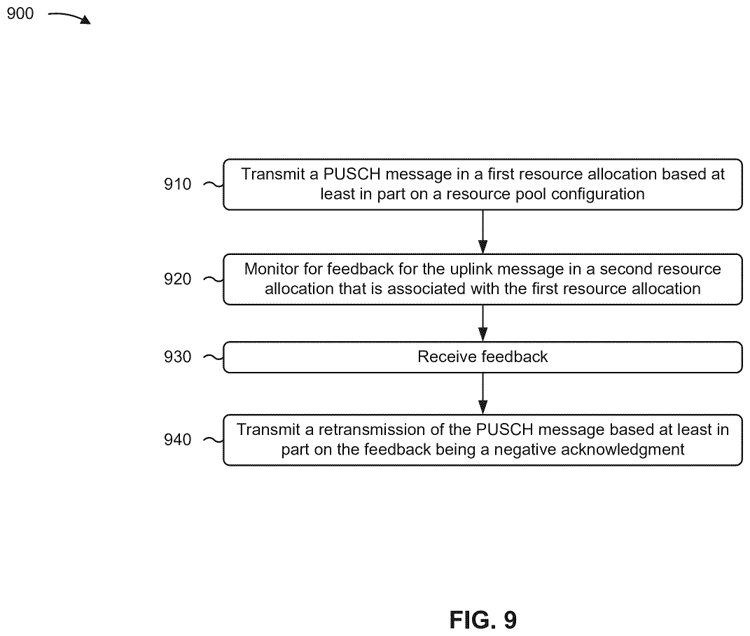

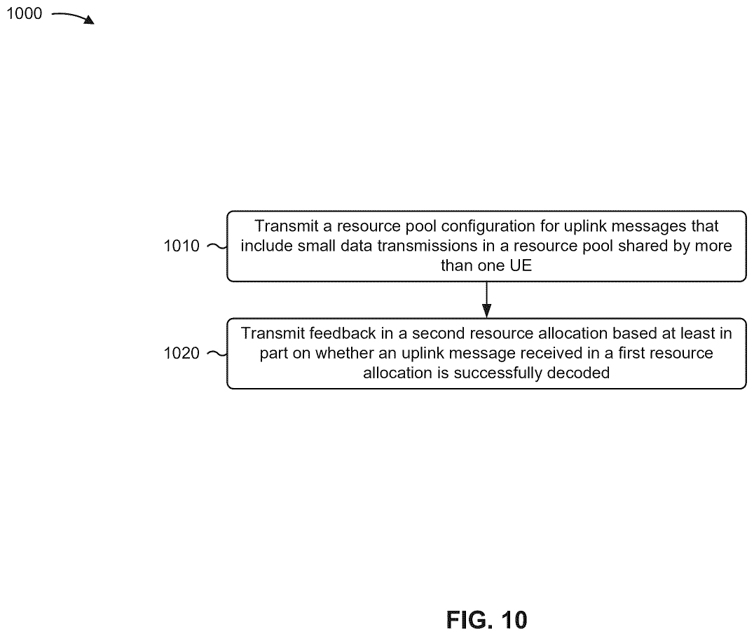

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with retransmission in a shared resource, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, process 800 of FIG. 8, process 900 of FIG. 9, process 1000 of FIG. 10, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, process 800 of FIG. 8, process 900 of FIG. 9, process 1000 of FIG. 10, or other processes as described herein. In some examples, executing instructions may include running the instructions, converting the instructions, compiling the instructions, or interpreting the instructions, among other examples.

In some aspects, a UE (e.g., a UE 120) includes means for receiving an ID for the UE and a resource pool configuration associated with a resource allocation for DCI associated with a retransmission grant within a resource pool shared by the UE and one or more other UEs; means for transmitting a PUSCH message based at least in part on the ID and the resource pool configuration; means for monitoring for the DCI based at least in part on the resource allocation for the DCI, wherein the DCI indicates the retransmission grant; means for receiving the DCI based at least in part on the resource allocation; or means for transmitting a retransmission of the PUSCH message in a resource associated with the retransmission grant.

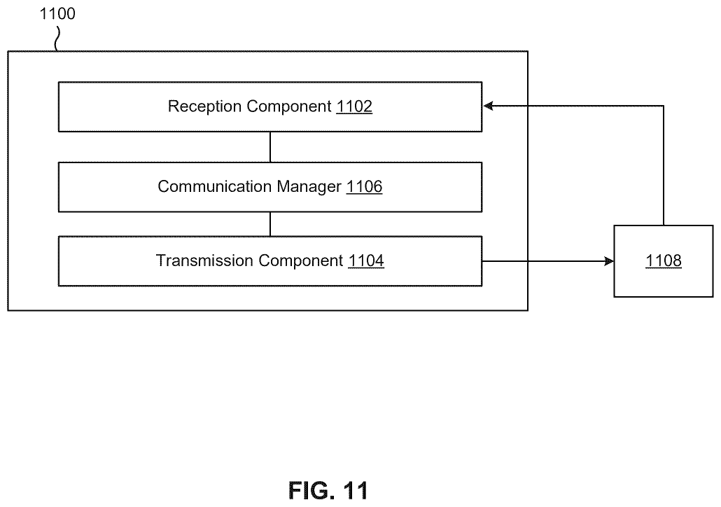

In some aspects, the UE includes means for transmitting an uplink message in a first resource allocation within a resource pool shared by more than one UE based at least in part on a resource pool configuration; means for monitoring for feedback for the uplink message in a second resource allocation that is associated with the first resource allocation; or means for transmitting a retransmission of the uplink message based at least in part on the feedback being a negative acknowledgment. The means for the UE to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11), or a transmission component (for example, transmission component 1104 depicted and described in connection with FIG. 11), among other examples.

In some aspects, a network entity (e.g., a network node 110) includes means for transmitting an ID for a UE and a resource pool configuration associated with a resource allocation for DCI with a retransmission grant within a resource pool shared by the UE and one or more other UEs; means for receiving a PUSCH message based at least in part on the ID and the resource pool configuration; or means for transmitting the DCI based at least in part on the resource allocation for the DCI.

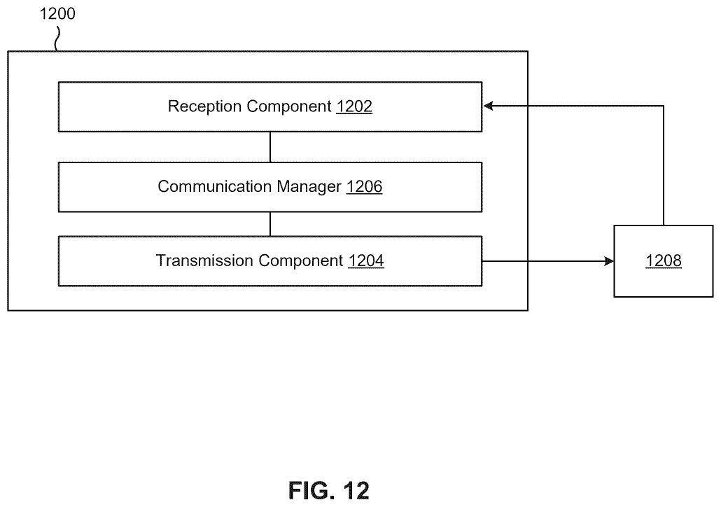

In some aspects, the network entity includes means for transmitting a resource pool configuration for uplink messages that include small data transmissions in a resource pool shared by more than one UE; or means for transmitting feedback in a second resource allocation based at least in part on whether an uplink message received in a first resource allocation is successfully decoded. In some aspects, the means for the network entity to perform operations described herein may include, for example, one or more of communication manager 155, processing system 145, a radio, one or more RF chains, one or more transceivers, one or more antennas, one or more modems, a reception component (for example, reception component 1202 depicted and described in connection with FIG. 12), or a transmission component (for example, transmission component 1204 depicted and described in connection with FIG. 12), among other examples.

Usage scenarios for devices may include integrated sensing and communication, immersive communication, AI and communication, massive communication, ubiquitous connectivity, and hyper-reliable low-latency communication. Devices and systems for such scenarios are to be designed for different capabilities, including for low user plane latency, low control plane latency, and high connection density.

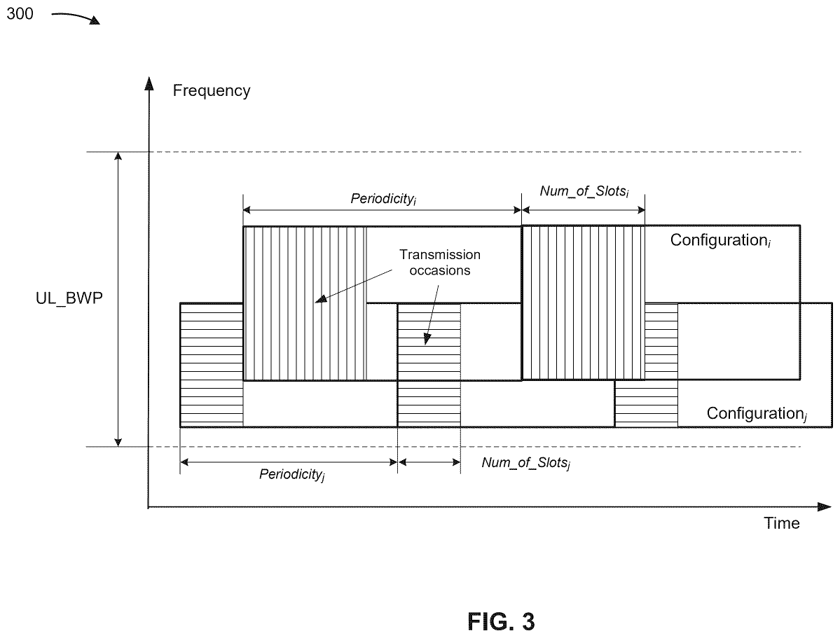

FIG. 3 is a diagram illustrating an example 300 of multiple CGs.

A network entity may transmit a CG configuration to a UE. For example, the network entity may transmit configuration information (e.g., in a radio resource configuration (RRC) message, in a downlink control information message, or in another signaling message) that identifies the CG. The configuration information identifying the CG may indicate a resource allocation (e.g., in a time domain, frequency domain, spatial domain, or code domain) or a periodicity associated with the resource allocation. The CG may identify a resource or set of resources available to the UE for transmission of an uplink communication (e.g., data or control information). For example, the CG configuration may identify a resource allocation for a PUSCH.

In some aspects, the CG configuration may configure contention-free CG communication with resources dedicated for the UE to transmit uplink communications. In this case, the CG configuration may indicate a resource allocation (e.g., in a time domain, frequency domain, spatial domain, or code domain) dedicated for the UE to use to transmit uplink communications. In some aspects, the CG configuration may configure the resource allocation for the UE to occur periodically, such that the resource allocation corresponds to periodically occurring transmission time occasions. When the UE has uplink data to transmit, the UE transmits the uplink data in the CG resources identified by the CG configuration. For example, the UE transmits the uplink data in one of the CG uplink occasions identified in the CG configuration using the configured resource allocation.

A CG configuration with regular periodic CG uplink occasions with a dedicated resource allocation for the UE may be convenient for a UE with periodic uplink traffic (e.g., with trivial jitter). The CG configuration may configure the periodicity associated with the resource allocation to associate CG uplink occasions with periodic nominal arrival times at which traffic to be transmitted to the network entity is expected to arrive at (or be ready to be transmitted by) the UE. However, the actual arrival times at which the traffic arrives (or is ready to be transmitted) by the UE may be different than the nominal arrival times, and this difference in times is known as jitter. In some aspects, traffic jittering may be handled by configuring multiple CG configurations around the nominal arrival times. In some aspects, multiple opportunities for the UE to transmit the uplink communication may be defined within a CG uplink occasion. The UE may be configured with multiple CG configurations to allow the UE to transmit multiple CG uplink communications and increase the likelihood that the network entity receives the communications. NR CG uplink may depend on dynamic grant re-transmission. In some aspects, to suppress a quantity of dynamic grants, the CG can be configured with blind re-transmissions via multiple repetitions.

In some cases, CG configurations with dedicated resources allocated per UE may be inefficient. For example, CG configurations with dedicated UE resources for a large number of UEs may result in consumption of an excessive amount of PUSCH resources. In this case, a considerable portion of the PUSCH resources may be inefficiently utilized, which reduces system capacity. For example, when multiple CG configurations for a UE are used for de-jittering, only a subset of CG resources may be effectively utilized. In another example, when multiple transmission opportunities are defined per CG uplink occasion, only one opportunity may be effectively utilized. In yet another example, when a blind repetition scheme is used for re-transmissions, a packet may have been already decoded after the first one or more repetitions (early decoding) such that a remainder of the repetitions are unnecessary. Unlike a downlink case, this type of inefficient consumption of system resources cannot be addressed by scheduling, as the network entity does not know exactly when traffic will arrive at the UEs.

UL CG may involve control signaling overhead (e.g., especially for small data transmission), and/or latency (e.g., compared with SR-based dynamic grant). A UE may be configured with multiple CG configurations with dedicated resource allocations, such as a number of contiguous slots (e.g., Num_of_Slotsᵢ or Num_of Slotsⱼ) within a period (e.g., Periodicityᵢ or Periodicityⱼ) for a configuration (e.g., Configurationᵢ or Configurationⱼ) within one UL BWP, as shown in example 300.

Example 300 shows there may be a quantity of transmission occasions (of a CG configuration), which may include transmission occasions in time (e.g., slots) and in frequency (e.g., physical resource blocks (PRBs)). Each CG configuration may include a periodicity and a quantity of slots that can be used for uplink transmission.

While UL CG improves the signaling overhead and latency, the dedicated resource utilization may not be optimized. For 6G, with an increased connection density for more devices, multiple UL CGs with dedicated resources for a massive amount of UEs may be very wasteful. Furthermore, with a more shortened latency for 6G, one CG with a fixed period may also limit a UE's immediate transmission with arrival data. To improve resource utilization, and to further improve latency, UL CG resources may be shared with UEs. For example, UEs may share one or more CG resource sets or resource pools. However, there may be collisions among UEs selecting the same resource(s), and the blind decoding overhead at the network entity may increase, consuming power and signaling resources.

Furthermore, within a shared resource pool, it is possible that a PUSCH message pointed to by a UCI from a UE may collide at least partially with a PUSCH message pointed to by another UCI from another UE. Based on a decoded UCI (e.g., allocated with a UE ID), the network entity may schedule a dedicated grant (i.e., implicit NACK to the initial transmission) for one or more collision-free retransmissions. Within a shared resource pool, it is possible that two different UE IDs are mapped to the same transmission occasion for small data transmission. Based on the decoding, the network node may indicate ACK or NACK corresponding to a small data transmission.

As indicated above, FIG. 3 is provided as an example. Other examples may differ from what is described with regard to FIG. 3.

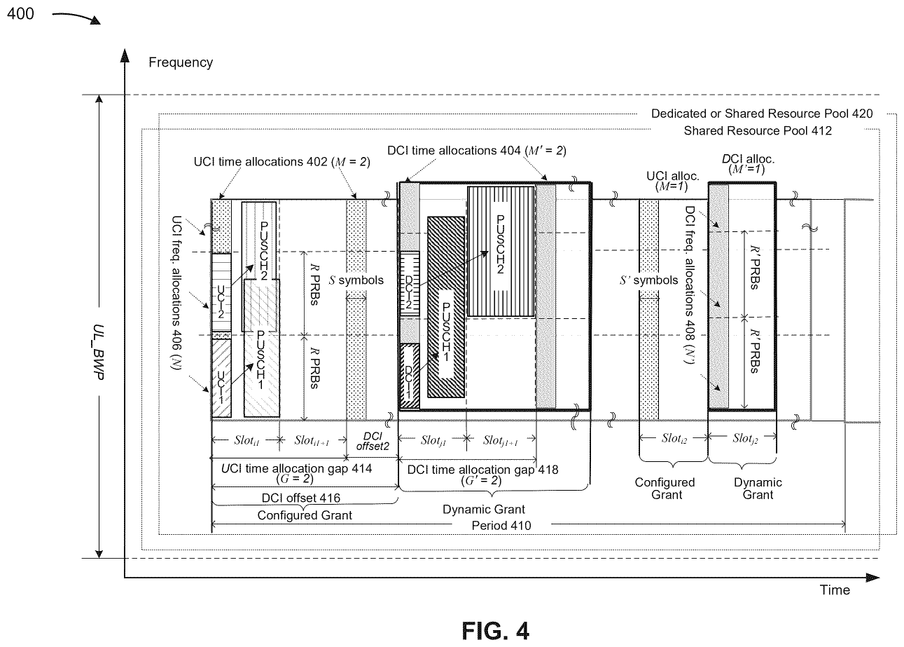

FIG. 4 is a diagram illustrating an example 400 of uplink retransmission allocation, in accordance with the present disclosure.

A network node may transmit DCI for retransmission as an implicit NACK to an initial configured grant transmission, where the DCI may be transmitted in a dedicated resource pool for dynamic grant only or in a shared resource pool with CG (e.g., the same or different shared resource pool with the initial transmission). A network entity may transmit a retransmission grant DCI within a dedicated resource pool or shared resource pool so that the UE can retransmit a PUSCH message. However, the DCI may be in one of multiple DCI transmission occasions or resource allocations. The UE may have to monitor the multiple DCI transmission occasions to receive the retransmission grant DCI, which consumes power.

According to various aspects described herein, a UE may reduce its blind searching and decoding overhead for detecting a retransmission grant DCI by identifying a resource allocation for the retransmission grant DCI based at least in part on a UE ID or a resource allocation for DCI. For example, a resource allocation for DCI may be based at least in part on a quantity (e.g., M′) of DCI time allocations and a quantity (e.g., N′) of DCI frequency allocations. In another example, a resource allocation for DCI may be based at least in part on the UE ID and a modulo (mod) operation with a quantity M′ of time allocations (e.g., slots) or a quantity N′ of frequency allocations (e.g., PRBs) within a resource pool. By using resource allocation for DCI or the UE ID for receiving a retransmission grant, the UE may monitor fewer DCI resource allocations (time allocations) and thus conserve power.

A DCI resource allocation for a retransmission grant DCI may include one or more symbols and one or more physical resource blocks (PRBs). The retransmission grant DCI may include a UE ID (obtained from the UCI associated with the initial PUSCH transmission) that is used for a resource allocation. The DCI may also include a resource pool index or ID for a shared resource pool for configured grant or dedicated resource pool for dynamic grant, if the resource pool is different from the initial transmission. The DCI may indicate time and frequency resources for one or more PUSCH (data) retransmissions. The DCI may include other information (e.g., MCS, HARQ) for decoding a retransmission of the PUSCH message.

Example 400 shows an example of a resource pool configuration for a retransmission grant, such as in DCI. The resource pool configuration may include a parameter for periodicity (e.g., period 410) with transmission time allocations over shared resources, a parameter for UCI time allocations 402 (e.g., quantity M of UCI time allocations) or DCI time allocations 404 (e.g., a quantity M′ of DCI time allocations) of each period within the shared resource pool 412, a parameter for UCI frequency allocations 406 (e.g., a quantity N of UCI frequency allocations) or DCI frequency allocations 408 (e.g., a quantity N′ of DCI frequency allocations) within the shared resource pool 412, and a parameter G for a UCI time allocation gap 414 (e.g., a quantity G of slots or mini-slots) between two adjacent UCI time allocations or a parameter G′ for a DCI time allocation gap 418 (e.g., quantity G′ of slots or mini-slots) between two adjacent DCI time allocations. Additionally, the resource pool configuration may include a parameter for DCI PRBs (e.g., a quantity R of PRBs of a UCI size in frequency) and/or a parameter for UCI symbols (e.g., a quantity S of symbols of a UCI size in time), or a parameter for DCI PRBs (e.g., a quantity R′ of PRBs of a DCI size in frequency) and/or a parameter for DCI symbols (e.g., a quantity S′ of symbols of a DCI size in time). In some aspects, one or more DCI time and frequency allocation parameters (e.g., M′, N′, or G′) may be configured with the same values as the respective one or more UCI time and frequency parameters (e.g., M, N, or G). In some aspects, one or more DCI time and frequency allocation parameters (e.g., M′, N′, or G′) may be configured with different values from the respective one or more UCI time and frequency parameters (e.g., M, N, or G), for example, based on the quality of service (QoS) requirement, channel condition for retransmissions, system resource utilization or loading, or alike. In some aspects, the DCI time and frequency allocations may be configured within a same shared resource pool as the UCI time and frequency allocations (e.g., in shared resource pool 412). In some aspects, the DCI time and frequency allocations may be configured within a different resource pool from the UCI time and frequency allocations (e.g., in dedicated or shared resource pool 420).

The UE may select a time resource (e.g., a slot or a mini-slot) for a UCI transmission allocation in time. The UE may select the time resource (e.g., a UCI time allocation of the M UCI time allocations within a period of a shared resource pool) based at least in part on the UE ID and the resource pool configuration (e.g., parameters M, N, and G, or the like). For example, the UE may select a time resource in a slot for a UCI transmission based at least in part on the (UE_ID mod M)×G (e.g., with G in slots). The modulo operation reflects the wraparound of the time allocations M of a period 410 within the shared resource pool 412 (e.g., M=2 with UCI time allocations in Slotᵢ₁ and Slotᵢ₁₊₂ or M=1 with UCI time allocation in Slotᵢ₂). With multiple UEs, there may be a UE_IDₐ for the UEₐ and a UE_ID_{b} for another UE_{b}, such that UCI_{slot,a}=(UE_IDₐ₁ mod M)×Gₛₗₒₜ for UEₐ and UCI_{slot,b}=(UE_ID_{b1} mod M)×Gₛₗₒₜ for UE_{b}, where the UE_IDₐ₁ and UE_ID_{b1} may be a subset of the ID bits of the respective UE_IDₐ and UE_ID_{b}. Based at least in part on the selected time allocation (e.g., UCIₛₗₒₜ in slot or UCIₘᵢₙᵢ₋ₛₗₒₜ in mini-slot), a UE may transmit a UCI at the first S symbols within the allocated slot or mini-slot (e.g., UCI 1 or UCI2 at the first S symbols within Slotᵢ) within a period of a shared resource pool.

The UE may select a frequency resource (e.g., R PRBs) for a UCI transmission allocation in frequency. The UE may select the frequency resource (e.g., a UCI frequency allocation of the N UCI frequency allocations within a shared resource pool) based at least in part on the UE ID and the resource pool configuration (e.g., parameters M, N, and G, or the like). In some aspects, the UE may select a frequency allocation for a UCI transmission based at least in part on the (UE_ID mod N)×R. The modulo operation reflects the wraparound of the frequency allocations N within the shared resource pool 412. With multiple UEs, there may be a UE_IDₐ for the UEₐ and a UE_ID_{b} for another UE_{b}, such that UCI_{PRB,a}=(UE_IDₐ₂ mod N)×R_{PRB} for UEₐ and UCI_{PRB,b}=(UE_ID_{b2} mod N)×R_{PRB} for UE_{b}, where the UE_IDₐ₂ and UE_ID_{b2} may be a subset of the ID bits of the respective UE_IDₐ and UE_ID_{b}. In some aspects, the UE may select a frequency allocation for a UCI transmission based at least in part on the UCI_{PRB}=random (N)×R_{PRB}, where random (N) is a random function selecting one frequency allocation from the N allocations. For example, a UE may randomly select a frequency allocation from the UCI frequency allocations 406, based at least in part on the UE ID (e.g., a random seed associated with the UE ID). Based at least in part on the selected UCI frequency allocation (e.g., UCI_{PRB}), a UE may transmit a UCI with R PRBs starting from the allocated PRB (e.g., UCI1 at the first UCI frequency allocation or UCI2 at the second UCI frequency allocation within Slotᵢ) within a shared resource pool.

In some aspects, a DCI resource allocation for the UE may be determined from among the DCI resource allocations based at least in part on the resource allocation for DCI. Example 400 shows that one DCI allocation may correspond to DCI time allocations (e.g., in Slotⱼ₁ or Slotⱼ₁₊₂ corresponding to DCI time allocations M′=2 or Slotⱼ₂ corresponding to DCI time allocation M′=1). There may be an association between UCI resource allocations and DCI resource allocations. For example, DCI1 may correspond to UCI1 and thus if the UE transmits UCI in the resource allocation of UCI1, the UE may expect the DCI transmission in the resource allocation of DCI1. Likewise for UCI2 and DCI2. In some aspects, the DCI may be transmitted within the same shared resource pool as the UCI (e.g., in shared resource pool 412). In some aspects, the DCI may be transmitted within a different resource pool from the UCI (e.g., in dedicated or shared resource pool 420).

In some aspects, the UE may select the DCI resource allocation based at least in part on the UE ID. In some aspects, the UE may select a time resource (e.g., a slot or a mini-slot) for a DCI transmission allocation in time. The UE may select the time resource (e.g., a DCI time allocation of the M′ DCI time allocations within a period of a shared resource pool) based at least in part on the UE ID and the resource pool configuration (e.g., parameters M′, N′, and G′, or the like). For example, the UE may select a time resource in a slot for a DCI transmission based at least in part on the (UE_ID mod M′) times G′ (e.g., with G′ in slots). There may be a DCI offset 416 (DCI_{offset}) between a start of the UCI time allocations and the start of the DCI time allocations, for example, based on the minimum processing time, the latency requirement (e.g., packet delay budget (PDB) or remaining PDB), or alike. The DCI offset 416 may be the offset in slots from the corresponding UCI allocation. With multiple UEs, there may be a UE_IDₐ for the UEₐ and a UE_ID_{b} for another UE_{b}, such that DCI_{slot,a}=(UE_IDₐ₁ mod M′)×G′ₛₗₒₜ+DCI_{offset} for UEₐ and DCI_{slot,b}=(UE_ID_{b1} mod M′)×G′ₛₗₒₜ+DCI_{offset} for UE_{b}, where the UE_IDₐ₁ and UE_ID_{b1} may be a subset of the ID bits of the respective UE_IDₐ and UE_ID_{b}. For example, UE_ID may be split into two subsets such as UE_ID₁ and UE_ID₂ (e.g., the UE_ID₁ may be a subset that contains a number of least significant bits (LSBs) or most significant bits (MSBs) of the UE_ID bits and the UE_ID₂ may be another subset that contains the remaining MSBs or LSBs of the UE_ID bits), where the UE_ID is split according to a cell radio network temporary identifier (C-RNTI) for the UE at an RRC-connected state, a stored C-RNTI for the UE at an RRC-inactive state, or a UE ID assigned by a network entity for resource selection. In another example, the UE may select a time resource in mini-slot for a DCI transmission based at least in part on the (UE_ID mod M′)×G′ (e.g., with G′ in mini-slots)+DCI_{offset}. In this case, the DCI transmission in time for UEₐ and UE_{b} may be allocated respectively with DCI_{mini-slot,a}=(UE_IDₐ₁ mod M′)×G′ₘᵢₙᵢ₋ₛₗₒₜ+DCI_{offset} and DCI_{mini-slot,b}=(UE_ID_{b1} mod M′)×G′ₘᵢₙᵢ₋ₛₗₒₜ+DCI_{offset}. Based at least in part on the selected time allocation (e.g., DCIₛₗₒₜ in slot or DCIₘᵢₙᵢ₋ₛₗₒₜ in mini-slot), a UE may monitor for and receive a retransmission grant DCI at the first S′ symbols within the allocated slot or mini-slot (e.g., DCI1 or DCI2 at the first S′ symbols within Slotⱼ₁) within a period of a shared resource pool.

The UE may select a frequency resource (e.g., R′ PRBs) for a DCI transmission allocation in frequency. The UE may select the frequency resource (e.g., a DCI frequency allocation of the N′ DCI frequency allocations 408 within a shared resource pool) based at least in part on the UE ID and the resource pool configuration (e.g., parameters M′, N′, and G′, or the like). In some aspects, the UE may select a frequency allocation for a DCI transmission based at least in part on the (UE_ID mod N′)×R′. With multiple UEs, there may be a UE_IDₐ for the UEₐ and a UE_ID_{b} for another UE_{b}, such that UCI_{PRB,a}=(UE_IDₐ₂ mod N′)×R′_{PRB} for UEₐ and UCI_{PRB,b}=(UE_ID_{b2} mod N′)×R′_{PRB} for UE_{b}, where the UE_IDₐ₂ and UE_ID_{b2} may be a subset of the ID bits of the respective UE_IDₐ and UE_ID_{b}. For example, UE_ID may be split into two subsets such as UE_ID₁ and UE_ID₂ (e.g., the UE_ID₁ may be a subset contains a number of LSBs or MSBs of the UE_ID bits and the UE_ID₂ may be another subset contains the remaining MSBs or LSBs of the UE_ID bits). In some aspects, the UE may select a frequency allocation for a DCI transmission based at least in part on the DCI_{PRB}=random (N′)×R′_{PRB}, where random (N′) is a random function selecting one frequency allocation from the N′ allocations. For example, a UE may randomly select a frequency allocation from the UCI frequency allocations 406, based at least in part on the UE ID (e.g., a random seed associated with the UE ID). Based at least in part on the selected DCI frequency allocation (e.g., DCI_{PRB}), a UE may monitor for and receive DCI with R′ PRBs starting from the allocated PRB (e.g., DCI1 at the first DCI frequency allocation or DCI2 at the second DCI frequency allocation within Slotⱼ₁) within a shared resource pool. The UE may then retransmit a PUSCH message using the retransmission grant indicated by the retransmission grant DCI.

As indicated above, FIG. 4 is provided as an example. Other examples may differ from what is described with regard to FIG. 4.

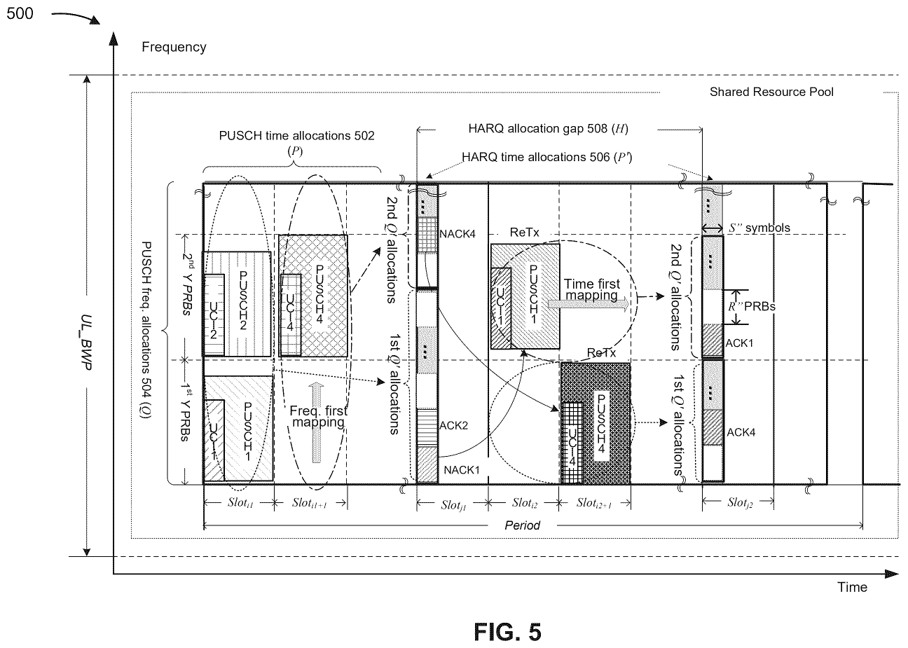

FIG. 5 is a diagram illustrating an example 500 of feedback for small data transmissions, in accordance with the present disclosure.

In some aspects, the UE may reduce the collisions of feedback for small data transmissions and reduce the collisions of the small data retransmissions. The network entity may transmit one or more resource pool configurations, where each resource pool configuration contains the parameters for uplink transmissions and retransmissions with small data.

A network entity may transmit an explicit HARQ ACK/NACK to an initial CG transmission, and a UE may retransmit using CG if a NACK is received. In some aspects, to reduce the UE's blind searching for ACK/NACK, the UE may determine a resource allocation for HARQ feedback within a shared resource pool based at least in part on a mapping to a transmission resource allocation. For example, a HARQ feedback resource allocation may include S″ symbols and R″ PRBs based at least in part on the configuration or specification (e.g., S″=1 symbol and R″=1 PRB). One HARQ feedback allocation (e.g., a time allocation within Slotⱼ₁ or Slotⱼ₂) may correspond to one or more PUSCH transmission allocations. Example 500 shows PUSCH time allocations 502, PUSCH frequency allocations 504, HARQ time allocations 506, and a HARQ allocation gap 508. In example 500, one HARQ allocation in Slotⱼ₁ corresponds to multiple PUSCH transmission allocations in Slotᵢ₁, Slotᵢ₁₊₁ and so forth.

In some aspects, the UE may follow a frequency first mapping (e.g., for HARQ feedbacks in Slotⱼ₁). Starting with the PUSCH transmissions within the Q frequency allocations in a first PUSCH time allocation (e.g., in Slotᵢ₁), the HARQ feedbacks may be mapped respectively from the lowest PRB increasingly with a first Q′ allocations. Continuing with the PUSCH transmissions within the Q frequency allocations in a second PUSCH time allocation (e.g., in Slotᵢ₁₊₁), the HARQ feedbacks may be mapped respectively from the lowest PRB increasingly with a second Q′ allocations. In some aspects, the HARQ frequency allocation Q′ may be the same as the PUSCH frequency allocation Q (e.g., one PUSCH to one HARQ frequency (R″ PRBs) mapping). In some aspects, the HARQ frequency allocation Q′ may be smaller than the PUSCH frequency allocation Q (e.g., more than one PUSCH to one HARQ frequency (R″ PRBs) mapping. In some aspects, with the modulo operation such as HARQ frequency allocation (the index of R″ PRBs)=PUSCH transmission (index within the frequency allocation Q) mod Q′. For example, with Q=8 and Q′=8 as configured, the index of PUSCH 1 within the frequency allocation Q is 1, and the index of PUSCH 2 within the frequency allocation Q is 2, the HARQ R″ PRBs index=1 mod 8=1 for PUSCH 1 and the HARQ R″ PRBs index=2 mod 8=2 for PUSCH 2. In another example, with Q=8 and Q′=4 as configured, the index of PUSCH 1 within the frequency allocation Q is 1 and the index of PUSCH 5 (not shown in the figure) within the frequency allocation Q is 5, the HARQ R″ PRBs index=1 mod 4=1 for PUSCH 1 and the HARQ R″ PRBs index=5 mod 4=1.

In an example, the UE 620 starts with the lowest frequency (e.g., for PUSCH1). NACK1 at the first R″ PRBs of the first Q′ HARQ allocations is mapped to PUSCH1. PUSCH2, in the same slot, is then mapped to ACK2 at the second R″ PRBs of the first Q′ HARQ allocations. The UE 620, having proceeded in frequency first, then proceeds in time from the first slot (Slotᵢ₁) to the second slot (Slotᵢ₁₊₁). In the second slot, the first PUSCH frequency allocation is empty (e.g., no transmission) and thus no HARQ allocation is mapped at the first R″ PRBs of the second Q′ HARQ allocations, and the second PUSCH frequency allocation is for PUSCH4, which is mapped to NACK4 at the second R″ PRBs of the second Q′ HARQ allocations. That is, based at least in part on the PUSCH transmission within Q frequency allocations at a PUSCH time allocation, the corresponding HARQ R″ PRBs allocation is mapped from the lowest R″ PRBs to the highest R″ PRBs to fill all of the ACK/NACKs within a Q′ HARQ allocations. If there is no transmission, then there is no ACK/NACK allocated or transmitted. If there are multiple transmissions, there will be multiple ACK/NACKs. To finish the first slot, the UE 620 maps HARQ R″ PRBs allocations within the first HARQ Q′ allocations crossing over all of the PUSCH frequency allocations (Q allocations). To finish the second slot, the UE 620 maps HARQ R″ PRBs allocations within the second HARQ Q′ allocations crossing over all of the PUSCH frequency allocations (Q allocations) starting with the lowest R″ PRBs. The UE 620 and the network entity 610 will both know where the ACK/NACK can be received and transmitted.

In some aspects, the UE 620 may follow a time-first mapping (e.g., for HARQ feedbacks in Slotⱼ₂). That is, the UE may proceed through each time slot at a first PUSCH frequency allocation within the Q frequency allocations, and then proceed through each time slot at a second PUSCH frequency allocation within the Q frequency allocations, and so forth. In an example, the UE 620 may start with the PUSCH transmissions in a first transmission frequency allocation (e.g., in the first Y PRBs), the HARQ feedbacks are mapped respectively from the lowest R″ PRBs increasingly with a first HARQ Q′ allocations (e.g., within the first PUSCH frequency allocation (e.g., in the first Y PRBs)). Continuing with the PUSCH transmissions in a second frequency allocation (e.g., in the second Y PRBs), the HARQ feedbacks are mapped respectively from the lowest R″ PRBs increasingly with a second HARQ Q′ allocations (e.g., within the second PUSCH frequency allocation (e.g., in the second Y PRBs)).

In some aspects, the Q′ HARQ allocations may not be aligned with the Q PUSCH allocation (e.g., the first Q′ HARQ allocation is aligned with the first Y PRBs and the second Q′ HARQ allocation is aligned with the second Y PRBs, as shown in Slotⱼ₂). In some aspects, the Q′ HARQ allocations may not be aligned with the Q PUSCH allocation (e.g., the first Q′ HARQ allocation is not aligned with the first Y PRBs and the second Q′ HARQ allocation is not aligned with the second Y PRBs, as shown in Slotⱼ₁).

In some aspects, the one or more Q′ HARQ allocations may be allocated at the first S″ symbols within a slot (e.g., as shown in Slotⱼ₁ and Slotⱼ₂). In some aspects, the one or more Q′ HARQ allocations may be allocated at the last S''symbols within a slot shared with PUSCH transmissions (e.g., the last S′ symbols in Slotᵢ₁₊₁ and Slotᵢ₂₊₁), where the one or more Q′ HARQ allocations may be separated with a gap symbol after PUSCH transmissions.

In some aspects, the PUSCH transmission based on HARQ feedback may be mapped at a same frequency resource (e.g., first Y PRBs for PUSCH 1 retransmission, not shown) with the initial PUSCH transmission (e.g., initial PUSCH 1 at Slotᵢ₁ and first Y PRBs). In some aspects, the PUSCH transmission based on HARQ feedback may be mapped at a different frequency resource (e.g., at Slotᵢ₂ and second Y PRBs for PUSCH 1 retransmission as shown) with the initial PUSCH transmission (e.g., initial PUSCH 1 at Slotᵢ₁ and first Y PRBs). for example, based on frequency hopping if configured.

As indicated above, FIG. 5 is provided as an example. Other examples may differ from what is described with regard to FIG. 5.

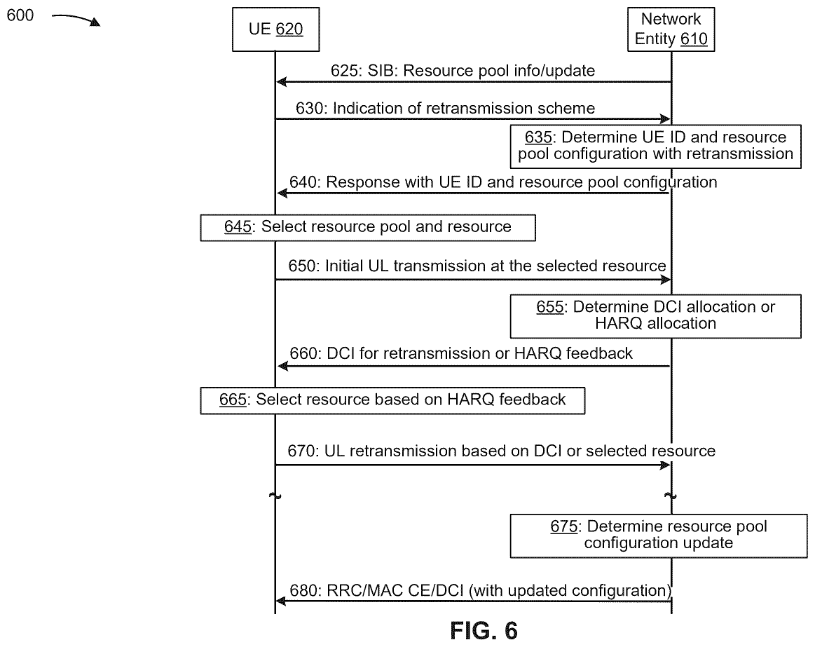

FIG. 6 is a diagram illustrating an example 600 of resource pool management, in accordance with the present disclosure. A UE 620 (e.g., UE 120) may communicate with a network entity 610 (e.g., network node 110) via a wireless communication (e.g., wireless communication network 100).

In some aspects, the network entity 610 may determine a resource pool configuration based at least in part on the number of UEs sharing CG resources within the resource pool and the traffic loading of the resource pool. The network entity 610 may determine the number of resource pools with different resource pool configurations, and update (e.g., via a broadcast system information block one (SIB1)) one or more resource pool configurations for the UE 620, as shown by reference number 625.

As shown by reference number 630, the UE 620 may transmit an indication of a retransmission scheme (e.g., retransmission with dynamic grant based on received DCI (as described in details in the connection with FIG. 4) or retransmission with configured grant based on HARQ feedback) (as described in details in the connection with FIG. 5) to the network entity 610.

As shown by reference number 635, the network entity 610 may determine a UE ID and a resource pool configuration with retransmission. The UE may determine a C-RNTI (e.g., to reduce possible transmission allocation overlapping with other transmission allocations associated with other C-RNTIs) based at least in part on one or more resource pool configurations (each resource pool configuration includes the parameters for transmission allocations (e.g., as described in details in the connection with FIGS. 4 and 5)) and the traffic load on the one or more resource pools.

As shown by reference number 640, the network entity 610 may transmit a response with the UE ID and resource pool configurations. Each resource pool configuration may include the retransmission scheme and associated parameters (e.g., the parameters for DCI mapping as described in FIG. 4 or the parameters for HARQ feedback mapping as described in FIG. 5).

The UE 620 may select a resource pool and resource, as shown by reference number 645. The UE 620 may select a resource pool and resource based at least in part on an UL transmission type, the associated retransmission scheme (e.g., with data using DCI dynamic grant for retransmission(s) as shown in FIG. 4, or small data transmission using configured grant for retransmission(s) as shown in FIG. 5), the associated QoS (e.g., the latency requirement such as packet delay budget (PDB)), and/or the retransmission timeline (e.g., the processing time). For example, the UE 620 may select the pool with DCI allocation or HARQ feedback allocation meeting the remaining PDB (e.g., retransmission within the remaining PDB) and retransmission processing time (e.g., a mini-time gap before retransmission). Alternatively, the UE 620 may select the pool with more (re)transmission allocations within a period for reliability requirement.

As shown by reference number 650, the UE 620 may transmit an initial uplink transmission (e.g., a UCI transmission indicating a PUSCH transmission as described in details in the connection with FIG. 4, a small data transmission with both UCI and PUSCH as described in details in the connection with FIG. 5) at the selected resource. As shown by reference number 655, the network entity 610 may determine the DCI allocation or HARQ feedback allocation in the same resource pool, or different resource pools, with the initial transmission. As shown by reference number 660, the network entity 610 may transmit the DCI with a retransmission grant in the DCI allocation (e.g., as described in details in the connection with FIG. 4) or transmit the HARQ feedback (e.g., as described in details in the connection with FIG. 5). The UE 620 may monitor for DCI or HARQ feedback at the corresponding DCI or transmission allocation(s).

As shown by reference number 665, the UE 620 may use a resource based on the DCI grant retransmission or select a resource based on the HARQ feedback. As shown by reference number 670, the UE 620 may retransmit the uplink transmission based at least in part on the received DCI or the HARQ feedback.

As shown by reference number 675, the network entity 610 may determine a resource pool configuration update to one or more resource pools based at least in part on the number of UEs, resource pool traffic loading, or transmission performance (e.g., number of retransmissions). As shown by reference number 680, the network entity 610 may transmit an indication of the resource pool configuration update (e.g., via an RRC message with one or more resource pool configurations containing updated parameter values, a MAC CE or DCI to activate or deactivate one or more parameter values configured in a resource pool configuration (e.g., activate a new value for period or quantity of time allocation or quantity for frequency allocation, or the like, as described in details in the connection with FIGS. 4 and 5)).

As indicated above, FIG. 6 is provided as an example. Other examples may differ from what is described with regard to FIG. 6.

FIG. 7 is a diagram illustrating an example process 700 performed, for example, at a UE or an apparatus of a UE. Example process 700 is an example where the apparatus or the UE (e.g., UE 620) performs operations associated with retransmission with shared resource.

As shown in FIG. 7, in some aspects, process 700 may include receiving an ID for the UE and a resource pool configuration associated with a resource allocation for DCI associated with a retransmission grant within a resource pool shared by the UE and one or more other UEs (block 710). For example, the UE (e.g., using reception component 1102 or communication manager 1106, depicted in FIG. 11) may receive an ID for the UE and a resource pool configuration associated with a resource allocation for DCI associated with a retransmission grant within a resource pool shared by the UE and one or more other UEs, as described above.

As further shown in FIG. 7, in some aspects, process 700 may include transmitting a PUSCH message based at least in part on the ID and the resource pool configuration (block 720). For example, the UE (e.g., using transmission component 1104 or communication manager 1106, depicted in FIG. 11) may transmit a PUSCH message based at least in part on the ID and the resource pool configuration, as described above.

As further shown in FIG. 7, in some aspects, process 700 may include monitoring for the DCI based at least in part on the resource allocation (block 730). For example, the UE (e.g., using communication manager 1106, depicted in FIG. 11) may monitor for the DCI based at least in part on the resource allocation, as described above.

As further shown in FIG. 7, in some aspects, process 700 may include receiving the DCI, wherein the DCI indicates the retransmission grant (block 740). For example, the UE (e.g., using reception component 1102 or communication manager 1106, depicted in FIG. 11) may receive the DCI, wherein the DCI indicates the retransmission grant, as described above.

As further shown in FIG. 7, in some aspects, process 700 may include transmitting a retransmission of the PUSCH message in a resource associated with the retransmission grant (block 750). For example, the UE (e.g., using transmission component 1104 or communication manager 1106, depicted in FIG. 11) may transmit a retransmission of the PUSCH message in a resource associated with the retransmission grant, as described above.

Process 700 may include additional aspects, such as any single aspect or any combination of aspects described below or in connection with one or more other processes described elsewhere herein.

In a first aspect, the resource allocation for the DCI indicates one or more symbols and one or more physical resource blocks or indicates a quantity of DCI time allocations and a quantity of DCI frequency allocations.

In a second aspect, alone or in combination with the first aspect, the DCI comprises an indication of the ID and a resource pool index for the resource pool.

In a third aspect, alone or in combination with one or more of the first and second aspects, the DCI further indicates time and frequency resources of the retransmission grant.

In a fourth aspect, alone or in combination with one or more of the first through third aspects, the resource allocation for the DCI is based at least in part on a resource allocation for UCI.

In a fifth aspect, alone or in combination with one or more of the first through fourth aspects, process 700 includes selecting the resource allocation for the DCI based at least in part on a first modulo operation of the ID and the quantity of DCI time allocations, and a second modulo operation of the ID and the quantity of DCI frequency allocations.

In a sixth aspect, alone or in combination with one or more of the first through fifth aspects, process 700 includes using the quantity of DCI time allocations and the quantity of DCI frequency allocations to select the resource allocation for the DCI based at least in part on a first modulo operation of the ID and the quantity of DCI time allocations, and a random selection from the DCI frequency allocations.

In a seventh aspect, alone or in combination with one or more of the first through sixth aspects, process 700 includes transmitting an indication of a retransmission scheme or one or more parameters associated with the retransmission scheme.

In an eighth aspect, alone or in combination with one or more of the first through seventh aspects, process 700 includes selecting the resource pool or the resource allocation based at least in part on the retransmission scheme.

In a ninth aspect, alone or in combination with one or more of the first through eighth aspects, selecting the resource pool or the resource allocation includes selecting the resource pool or the resource allocation further based at least in part on an expected quality of service or a retransmission processing timeline.

In a tenth aspect, alone or in combination with one or more of the first through ninth aspects, selecting the resource pool or the resource allocation includes selecting the resource pool or the resource allocation based at least in part on the resource allocation satisfying a remaining packet delay budget.

In an eleventh aspect, alone or in combination with one or more of the first through tenth aspects, selecting the resource pool or the resource allocation includes selecting the resource pool of the resource pool configuration having a greatest quantity of retransmission allocations within a period for a reliability requirement.

In a twelfth aspect, alone or in combination with one or more of the first through eleventh aspects, selecting the resource pool or the resource allocation includes selecting the resource pool or the resource allocation based at least in part on feedback for the PUSCH message.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network entity or an apparatus of a network entity. Example process 800 is an example where the apparatus or the network entity (e.g., network entity 610) performs operations associated with retransmission with a shared resource.

As shown in FIG. 8, in some aspects, process 800 may include transmitting an ID for a UE and a resource pool configuration associated with a resource allocation for DCI associated with a retransmission grant within a resource pool shared by the UE and one or more other UEs (block 810). For example, the network entity (e.g., using transmission component 1204 or communication manager 1206, depicted in FIG. 12) may transmit an ID for a UE and a resource pool configuration associated with a resource allocation for DCI associated with a retransmission grant within a resource pool shared by the UE and one or more other UEs, as described above.

As further shown in FIG. 8, in some aspects, process 800 may include receiving a PUSCH message based at least in part on the ID and the resource pool configuration (block 820). For example, the network entity (e.g., using reception component 1202 or communication manager 1206, depicted in FIG. 12) may receive a PUSCH message based at least in part on the ID and the resource pool configuration, as described above.

As further shown in FIG. 8, in some aspects, process 800 may include transmitting the DCI based at least in part on the resource allocation (block 830). For example, the network entity (e.g., using transmission component 1204 or communication manager 1206, depicted in FIG. 12) may transmit the DCI based at least in part on the resource allocation, as described above.

Process 800 may include additional aspects, such as any single aspect or any combination of aspects described below or in connection with one or more other processes described elsewhere herein.

In a first aspect, process 800 includes receiving a retransmission of the PUSCH message in a resource associated with the retransmission grant.

In a second aspect, alone or in combination with the first aspect, the DCI indicates the ID, a resource pool index for the resource pool, or time and frequency resources of the retransmission grant.

In a third aspect, alone or in combination with one or more of the first and second aspects, the resource allocation for the DCI is based at least in part on a resource allocation for uplink control information.

In a fourth aspect, alone or in combination with one or more of the first through third aspects, process 800 includes receiving an indication of a retransmission scheme or one or more parameters associated with the retransmission scheme.

In a fifth aspect, alone or in combination with one or more of the first through fourth aspects, process 800 includes selecting the resource allocation for the DCI or a resource allocation for feedback based at least in part on a resource pool used for the PUSCH message.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a UE or an apparatus of a UE. Example process 900 is an example where the apparatus or the UE (e.g., UE 620) performs operations associated with retransmission with a shared resource.

As shown in FIG. 9, in some aspects, process 900 may include transmitting a PUSCH message in a first resource allocation within a resource pool shared by more than one UE, based at least in part on a resource pool configuration (block 910). For example, the UE (e.g., using transmission component 1104 or communication manager 1106, depicted in FIG. 11) may transmit a PUSCH message in a first resource allocation within a resource pool shared by more than one UE, based at least in part on a resource pool configuration, as described above. In some aspects, the second resource allocation may be in a shared resource pool.

As further shown in FIG. 9, in some aspects, process 900 may include monitoring for feedback (e.g., HARQ feedback for the PUSCH message) for the PUSCH message in a second resource allocation that is associated with the first resource allocation (block 920). For example, the UE (e.g., using communication manager 1106, depicted in FIG. 11) may monitor for feedback for the PUSCH message in a second resource allocation that is associated with the first resource allocation, as described above.

As further shown in FIG. 9, in some aspects, process 900 may include receiving feedback, such as HARQ feedback for the PUSCH message (block 930). For example, the UE (e.g., using reception component 1102 or communication manager 1106, depicted in FIG. 11) may receive feedback, as described above. The feedback may be received in, for example, DCI.

As further shown in FIG. 9, in some aspects, process 900 may include transmitting a retransmission of the PUSCH message based at least in part on the feedback being a negative acknowledgment (block 940). For example, the UE (e.g., using transmission component 1104 or communication manager 1106, depicted in FIG. 11) may transmit a retransmission of the PUSCH message based at least in part on the feedback being a negative acknowledgment, as described above.

Process 900 may include additional aspects, such as any single aspect or any combination of aspects described below or in connection with one or more other processes described elsewhere herein.

In a first aspect, the second resource allocation is mapped with the first resource allocation according to a frequency first mapping.

In a second aspect, alone or in combination with the first aspect, the frequency first mapping comprises firstly mapping one or more first resource allocations across all frequency allocations at a first time allocation.

In a third aspect, alone or in combination with one or more of the first and second aspects, the second resource allocation is mapped with the first resource allocation according to a time first mapping.

In a fourth aspect, alone or in combination with one or more of the first through third aspects, the time first mapping comprises firstly mapping one or more first resource allocations across all time allocations at a first frequency allocation.

In a fifth aspect, alone or in combination with one or more of the first through fourth aspects, process 900 includes transmitting an indication of a retransmission scheme or one or more parameters associated with small data transmissions.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network entity or an apparatus of a network entity. Example process 1000 is an example where the apparatus or the network entity (e.g., network entity 610) performs operations associated with retransmission with shared resource.

As shown in FIG. 10, in some aspects, process 1000 may include transmitting a resource pool configuration for uplink messages that include small data transmissions in a resource pool shared by more than one UE (block 1010). For example, the network entity (e.g., using transmission component 1204 or communication manager 1206, depicted in FIG. 12) may transmit a resource pool configuration for uplink messages that include small data transmissions in a resource pool shared by more than one UE, as described above.

As further shown in FIG. 10, in some aspects, process 1000 may include transmitting feedback (e.g., HARQ feedback) in a second resource allocation based at least in part on whether an uplink message received in a first resource allocation is successfully decoded (block 1020). For example, the network entity (e.g., using transmission component 1204 or communication manager 1206, depicted in FIG. 12) may transmit feedback in a second resource allocation based at least in part on whether an uplink message received in a first resource allocation is successfully decoded, as described above.

Process 1000 may include additional aspects, such as any single aspect or any combination of aspects described below or in connection with one or more other processes described elsewhere herein.

In a first aspect, the second resource allocation is mapped to the first resource allocation according to frequency first and time second.

In a second aspect, alone or in combination with the first aspect, the first resource allocation and the second resource allocation are in a same physical resource block.

In a third aspect, alone or in combination with one or more of the first and second aspects, the second resource allocation is mapped to the first resource allocation according to time first and frequency second.

In a fourth aspect, alone or in combination with one or more of the first through third aspects, the first resource allocation shares an order of a first set of time slots that matches an order of a second set of time slots for the second resource allocation.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a UE, or a UE may include the apparatus 1100. In some aspects, the apparatus 1100 includes a reception component 1102, a transmission component 1104, or a communication manager 1106, which may be in communication with one another (for example, via one or more buses or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 140 described in connection with FIG. 1) of the UE.

In some aspects, the apparatus 1100 may be configured to perform one or more operations described herein in connection with FIGS. 1-6. Additionally, or alternatively, the apparatus 1100 may be configured to perform one or more processes described herein, such as process 700 of FIG. 7, process 900 of FIG. 9, or a combination thereof. In some aspects, the apparatus 1100 or one or more components shown in FIG. 11 may include one or more components of the UE described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the UE described above in connection with FIG. 1, such as a radio, one or more RF chains, one or more transceivers, or one or more modems, each of which may in turn be coupled with one or more antennas of the UE.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1104 may be co-located with the reception component 1102.

The communication manager 1106 may support operations of the reception component 1102 or the transmission component 1104. For example, the communication manager 1106 may receive information associated with configuring reception of communications by the reception component 1102 or transmission of communications by the transmission component 1104. Additionally, or alternatively, the communication manager 1106 may generate or provide control information to the reception component 1102 or the transmission component 1104 to control reception or transmission of communications.

In some aspects, the reception component 1102 may receive an ID for the UE and a resource pool configuration associated with a resource allocation for DCI that indicates a retransmission grant within a resource pool shared by more than one UE. The transmission component 1104 may transmit a PUSCH message based at least in part on the ID and the resource pool configuration. The communication manager 1106 may monitor for the DCI in the resource allocation. The reception component 1102 may receive the DCI in the resource allocation. The transmission component 1104 may transmit a retransmission of the PUSCH message in a resource associated with the retransmission grant.

The communication manager 1106 may select the resource allocation for the DCI based at least in part on a first modulo operation of the ID and a quantity of DCI time allocations, and a second modulo operation of the ID and a quantity of DCI frequency allocations. The communication manager 1106 may select the resource allocation for the DCI based at least in part on a first modulo operation of the ID and a quantity of DCI time allocations, and a random selection from DCI frequency allocations.

The transmission component 1104 may transmit an indication of a retransmission scheme or one or more parameters associated with the retransmission scheme. The communication manager 1106 may select the resource pool or the resource allocation based at least in part on the retransmission scheme.

In some aspects, the transmission component 1104 may transmit an uplink message (e.g., PUSCH message) in a first resource allocation within a resource pool shared by more than one UE based at least in part on a resource pool configuration. The communication manager 1106 may monitor for feedback for the uplink message in a second resource allocation that is mapped to the first resource allocation. The second resource allocation may be within a resource pool shared by more than one UE. The reception component 1102 may receive DCI that indicates a retransmission grant. The transmission component 1104 may transmit a retransmission of the uplink message in a resource associated with the retransmission grant based at least in part on the feedback being a negative acknowledgment (e.g., NACK).

The transmission component 1104 may transmit an indication of a retransmission scheme or one or more parameters associated with small data transmissions after receiving feedback.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a network entity, or a network entity may include the apparatus 1200. In some aspects, the apparatus 1200 includes a reception component 1202, a transmission component 1204, or a communication manager 1206, which may be in communication with one another (for example, via one or more buses or one or more other components). In some aspects, the communication manager 1206 is the communication manager 155 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 145 described in connection with FIG. 1) of the network entity.

In some aspects, the apparatus 1200 may be configured to perform one or more operations described herein in connection with FIGS. 1-6. Additionally, or alternatively, the apparatus 1200 may be configured to perform one or more processes described herein, such as process 800 of FIG. 8, process 1000 of FIG. 10, or a combination thereof. In some aspects, the apparatus 1200 or one or more components shown in FIG. 12 may include one or more components of the network entity described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the network entity described above in connection with FIG. 1, such as a radio, one or more RF chains, one or more transceivers, or one or more modems, each of which may in turn be coupled with one or more antennas of the network entity.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the network entity described above in connection with FIG. 1, such as a radio, one or more RF chains, one or more transceivers, or one or more modems, each of which may in turn be coupled with one or more antennas of the network entity described in connection with FIG. 1. In some aspects, the transmission component 1204 may be co-located with the reception component 1202.

The communication manager 1206 may support operations of the reception component 1202 or the transmission component 1204. For example, the communication manager 1206 may receive information associated with configuring reception of communications by the reception component 1202 or transmission of communications by the transmission component 1204. Additionally, or alternatively, the communication manager 1206 may generate or provide control information to the reception component 1202 or the transmission component 1204 to control reception or transmission of communications.

In some aspects, the transmission component 1204 may transmit an ID for a UE and a resource pool configuration associated with a resource allocation for DCI that indicates a retransmission grant within a resource pool shared by more than one UE. The reception component 1202 may receive a PUSCH message based at least in part on the ID and the resource pool configuration. The transmission component 1204 may transmit the DCI based at least in part on the resource allocation.

The reception component 1202 may receive a retransmission of the PUSCH message in a resource associated with the retransmission grant. The reception component 1202 may receive an indication of a retransmission scheme or one or more parameters associated with the retransmission scheme.

The communication manager 1206 may select the resource allocation for the DCI or a resource allocation for feedback based at least in part on a resource pool used for the PUSCH message.

In some aspects, the transmission component 1204 may transmit a resource pool configuration for uplink messages that include small data transmissions in a resource pool shared by more than one UE. The transmission component 1204 may transmit feedback in a second resource allocation based at least in part on whether an uplink message received in a first resource allocation is successfully decoded.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving an identifier (ID) for the UE and a resource pool configuration associated with a resource allocation for downlink control information (DCI) associated with a retransmission grant within a resource pool shared by the UE and one or more other UEs; transmitting a physical uplink shared channel (PUSCH) message based at least in part on the ID and the resource pool configuration; monitoring for the DCI based at least in part on the resource allocation; receiving the DCI, wherein the DCI indicates the retransmission grant; and transmitting a retransmission of the PUSCH message in a resource associated with the retransmission grant.

Aspect 2: The method of Aspects 1, wherein the DCI comprises an indication of the ID and a resource pool index for the resource pool.

Aspect 3: The method of any of Aspects 1-2, wherein the DCI indicates time and frequency resources of the retransmission grant.

Aspect 4: The method of Aspect 1, wherein the resource allocation for the DCI further indicates a quantity of DCI time allocations and a quantity of DCI frequency allocations.

Aspect 5: The method of Aspect 4, further comprising selecting the resource allocation for the DCI based at least in part on a first modulo operation of the ID and a quantity of DCI time allocations, and a second modulo operation of the ID and a quantity of DCI frequency allocations.

Aspect 6: The method of any of Aspect 4, further comprising selecting the resource allocation for the DCI based at least in part on a first modulo operation of the ID and the quantity of DCI time allocations, and a random selection from DCI frequency allocations.

Aspect 7: The method of any of Aspects 1-6, further comprising transmitting an indication of a retransmission scheme or one or more parameters associated with the retransmission scheme.

Aspect 8: The method of Aspect 7, further comprising selecting the resource pool or the resource allocation based at least in part on the retransmission scheme.

Aspect 9: The method of Aspect 8, wherein selecting the resource pool or the resource allocation includes selecting the resource pool or the resource allocation further based at least in part on an expected quality of service or a retransmission processing timeline.

Aspect 10: The method of Aspect 8, wherein selecting the resource pool or the resource allocation includes selecting the resource pool or the resource allocation based at least in part on the resource allocation satisfying a remaining packet delay budget.

Aspect 11: The method of Aspect 8, wherein selecting the resource pool or the resource allocation includes selecting the resource pool of the resource pool configuration having a greatest quantity of retransmission allocations within a period for a reliability requirement.

Aspect 12: The method of Aspect 8, wherein selecting the resource pool or the resource allocation includes selecting the resource pool or the resource allocation based at least in part on feedback for the PUSCH message.

Aspect 13: A method of wireless communication performed by a network entity, comprising: transmitting an identifier (ID) for a user equipment (UE) and a resource pool configuration associated with a resource allocation for downlink control information (DCI) associated with a retransmission grant within a resource pool shared by the UE and one or more other UEs; receiving a physical uplink shared channel (PUSCH) message based at least in part on the ID and the resource pool configuration; and transmitting the DCI in the resource allocation.

Aspect 14: The method of Aspect 13, further comprising receiving a retransmission of the PUSCH message in a resource associated with the retransmission grant.

Aspect 15: The method of any of Aspects 13-14, wherein the DCI indicates the ID, a resource pool index for the resource pool, or time and frequency resources of the retransmission grant.

Aspect 16: The method of any of Aspects 13-15, further comprising receiving an indication of a retransmission scheme or one or more parameters associated with the retransmission scheme.

Aspect 17: The method of any of Aspects 13-16, further comprising selecting the resource allocation for the DCI or a resource allocation for feedback based at least in part on the resource pool used for the PUSCH message.

Aspect 20: A method of wireless communication performed by a user equipment (UE), comprising: transmitting physical uplink shared channel (PUSCH) message in a first resource allocation within a resource pool shared by more than one UE, based at least in part on a resource pool configuration; monitoring for feedback for the PUSCH message in a second resource allocation that is associated with the first resource allocation; and transmitting a retransmission of the PUSCH message based at least in part on the feedback being a negative acknowledgment.

Aspect 21: The method of Aspect 20, wherein the second resource allocation is mapped with the first resource allocation according to a frequency first mapping.

Aspect 22: The method of Aspect 21, wherein the frequency first mapping comprises firstly mapping one or more first resource allocations across all frequency allocations at a first time allocation.

Aspect 23: The method of any of Aspects 20-22, wherein the second resource allocation is mapped with the first resource allocation according to a time first mapping.

Aspect 24: The method of Aspect 23, wherein the time first mapping comprises firstly mapping one or more first resource allocations across all time allocations at a first frequency allocation.

Aspect 25: The method of any of Aspects 20-24, further comprising transmitting an indication of a retransmission scheme or one or more parameters associated with small data transmissions.

Aspect 26: A method of wireless communication performed by a network entity, comprising: transmitting a resource pool configuration for uplink messages that include small data transmissions in a resource pool shared by more than one user equipment (UE); and transmitting feedback in a second resource allocation based at least in part on whether an uplink message received in a first resource allocation is successfully decoded.

Aspect 27: The method of Aspect 26, wherein the second resource allocation is mapped to the first resource allocation according to frequency first and time second.

Aspect 28: The method of Aspect 27, wherein the first resource allocation and the second resource allocation are in a same physical resource block.

Aspect 29: The method of any of Aspects 26-28, wherein the second resource allocation is mapped to the first resource allocation according to time first and frequency second.

Aspect 30: The method of Aspect 29, wherein the first resource allocation shares an order of a first set of time slots that matches an order of a second set of time slots for the second resource allocation.

Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-30.

Aspect 32: An apparatus for wireless communication at a device, the apparatus comprising one or more memories and one or more processors coupled to the one or more memories, the one or more processors configured to cause the device to perform the method of one or more of Aspects 1-30.

Aspect 33: An apparatus for wireless communication, the apparatus comprising at least one means for performing the method of one or more of Aspects 1-30.

Aspect 34: A non-transitory computer-readable medium storing code for wireless communication, the code comprising instructions executable by one or more processors to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

Aspect 36: A device for wireless communication, the device comprising a processing system that includes one or more processors and one or more memories coupled with the one or more processors, the processing system configured to cause the device to perform the method of one or more of Aspects 1-30.

Aspect 37: An apparatus for wireless communication at a device, the apparatus comprising one or more memories and one or more processors coupled to the one or more memories, the one or more processors individually or collectively configured to cause the device to perform the method of one or more of Aspects 1-30.

Aspect 38: A device comprising a processing system that includes one or more processors and one or more code-storing memories coupled with the one or more processors, the processing system configured to cause the device to perform the method of one or more of Aspects 1-30.

Aspect 39: A device comprising a processing system that includes processor circuitry and code-storing memory circuitry, the processing system configured to cause the device to perform the method of one or more of Aspects 1-30.

Aspect 40: A network entity, comprising: a processing system that includes one or more processors and one or more code-storing memories coupled with the one or more processors, the processing system configured to cause the network entity to: transmit a resource pool configuration for uplink messages that include small data transmissions in a resource pool shared by more than one user equipment (UE); and transmit feedback in a second resource allocation based at least in part on whether an uplink message received in a first resource allocation is successfully decoded.

Aspect 41: The network entity of Aspect 40, wherein the second resource allocation is mapped to the first resource allocation according to frequency first and time second.

Aspect 42: The network entity of Aspect 41, wherein the first resource allocation and the second resource allocation are in a same physical resource block.

Aspect 43: The network entity of Aspect 40, wherein the second resource allocation is mapped to the first resource allocation according to time first and frequency second.

Aspect 44: The network entity of Aspect 43, wherein the first resource allocation shares an order of a first set of time slots that matches an order of a second set of time slots for the second resource allocation.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive an identifier (ID) for the UE and a resource pool configuration associated with a resource allocation for downlink control information (DCI) associated with a retransmission grant within a resource pool shared by the UE and one or more other UEs;
transmit a physical uplink shared channel (PUSCH) message based at least in part on the ID and the resource pool configuration;
monitor for the DCI based at least in part on the resource allocation;
receive the DCI, wherein the DCI indicates the retransmission grant; and
transmit a retransmission of the PUSCH message in a resource associated with the retransmission grant.

2. The UE of claim 1, wherein the DCI comprises an indication of the ID and a resource pool index for the resource pool.

3. The UE of claim 1, wherein the DCI further indicates time and frequency resources of the retransmission grant.

4. The UE of claim 1, wherein the resource allocation for the DCI indicates a quantity of DCI time allocations and a quantity of DCI frequency allocations.

5. The UE of claim 4, wherein the processing system is configured to cause the UE to select the resource allocation for the DCI based at least in part on a first modulo operation of the ID and the quantity of DCI time allocations, and a second modulo operation of the ID and the quantity of DCI frequency allocations.

6. The UE of claim 4, wherein the processing system is configured to cause the UE to select the resource allocation for the DCI based at least in part on a first modulo operation of the ID and the quantity of DCI time allocations, and a random selection from the DCI frequency allocations.

7. The UE of claim 1, wherein the processing system is configured to cause the UE to transmit an indication of a retransmission scheme or one or more parameters associated with the retransmission scheme.

8. The UE of claim 7, wherein the processing system is configured to cause the UE to select the resource pool or the resource allocation based at least in part on the retransmission scheme.

9. The UE of claim 8, wherein to select the resource pool or the resource allocation, the processing system is further configured to cause the UE to select the resource pool or the resource allocation further based at least in part on an expected quality of service or a retransmission processing timeline.

10. The UE of claim 8, wherein to select the resource pool or the resource allocation, the processing system is further configured to cause the UE to select the resource pool or the resource allocation based at least in part on the resource allocation satisfying a remaining packet delay budget.

11. The UE of claim 8, wherein to select the resource pool or the resource allocation, the processing system is further configured to cause the UE to select the resource pool of the resource pool configuration having a greatest quantity of retransmission allocations within a period for a reliability requirement.

12. The UE of claim 8, wherein to select the resource pool or the resource allocation, the processing system is further configured to cause the UE to select the resource pool or the resource allocation based at least in part on feedback for the PUSCH message.

13. A network entity, comprising:
a processing system that includes one or more processors and one or more code-storing memories coupled with the one or more processors, the processing system configured to cause the network entity to:
transmit an identifier (ID) for a user equipment (UE) and a resource pool configuration associated with a resource allocation for downlink control information (DCI) associated with a retransmission grant within a resource pool shared by the UE and one or more other UEs;
receive a physical uplink shared channel (PUSCH) message based at least in part on the ID and the resource pool configuration; and
transmit the DCI based at least in part on the resource allocation.

14. The network entity of claim 13, wherein the processing system is configured to cause the network entity to receive an indication of a retransmission scheme or one or more parameters associated with the retransmission scheme.

15. A user equipment (UE), comprising:
a processing system that includes one or more processors and one or more code-storing memories coupled with the one or more processors, the processing system configured to cause the UE to:
transmit a physical uplink shared channel (PUSCH) message in a first resource allocation within a resource pool shared by more than one UE, based at least in part on a resource pool configuration;
monitor for feedback for the PUSCH message in a second resource allocation that is associated with the first resource allocation; and
transmit a retransmission of the PUSCH message based at least in part on the feedback being a negative acknowledgment.

16. The UE of claim 15, wherein the second resource allocation is mapped with the first resource allocation according to a frequency first mapping.

17. The UE of claim 16, wherein the frequency first mapping comprises firstly mapping one or more first resource allocations across all frequency allocations at a first time allocation.

18. The UE of claim 15, wherein the second resource allocation is mapped with the first resource allocation according to a time first mapping.

19. The UE of claim 18, wherein the time first mapping comprises firstly mapping one or more first resource allocations across all time allocations at a first frequency allocation.

20. The UE of claim 15, wherein the processing system is configured to cause the UE to transmit an indication of a retransmission scheme or one or more parameters associated with small data transmissions.
